(19) United States
(12) Patent Application Publication
(10) Pub. No.: US 2025/0264497 A1
(43) Pub. Date: Aug. 21, 2025

(54) SCANNING PROBE MICROSCOPE

(71) Applicant: INFINITESIMA LIMITED, Abingdon (GB)

(72) Inventor: Andrew Humphris, Abingdon (GB)

(21) Appl. No.: 19/199,842

(22) Filed: May 6, 2025

Related U.S. Application Data
(63) Continuation-in-part of application No. PCT/EP2024/081331, filed on Nov. 6, 2024.

(30) Foreign Application Priority Data
Nov. 9, 2023 (EP) 23208906.0

(51) Int. Cl. G01Q 20/02; G01Q 10/06; G01Q 60/38

(52) U.S. Cl. CPC G01Q 20/02; G01Q 10/065; G01Q 60/38

(57) ABSTRACT

A scanning probe microscope is configured to measure a topography of a sample. The microscope includes a probe mount and a cantilever carried by the probe mount. The cantilever extends from a proximal end at the probe mount to a distal end remote from the probe mount. The microscope also includes a probe tip at the distal end of the cantilever, a scanning system configured to generate a relative scanning motion between the probe mount and the sample, and an interferometer configured to measure a height of the distal end of the cantilever to generate a height measurement signal. The microscope further includes a signal processor configured to monitor the height measurement signal to obtain a series of topography measurements indicative of a topography of the sample, a height actuation system configured to adjust a height of the proximal end of the cantilever by moving the probe mount under control of a height control signal, a photothermal actuation system configured to bend the cantilever by illuminating the cantilever with an actuation beam under control of a photothermal offset signal and an oscillation signal, an oscillation signal generator configured to generate the oscillation signal, and a control system configured to adjust the photothermal offset signal and the height control signal on a basis of the height measurement signal.

### TECHNICAL FIELD

The present invention relates to a scanning probe microscope, and an associated method.

### BACKGROUND

WO2010067129A1 discloses a dynamic probe detection system for use with a scanning probe microscope of the type that includes a probe that is moved repeatedly towards and away from a sample surface. As a sample surface is scanned, an interferometer generates an output height signal indicative of a path difference between light reflected from the probe and a height reference beam. Signal processing apparatus monitors the height signal and derives a measurement for each oscillation cycle that is indicative of the height of the probe. This enables extraction of a measurement that represents the height of the sample, without recourse to averaging or filtering, that may be used to form an image of the sample. The detection system may also include a feedback mechanism that is operable to maintain the average value of a feedback parameter at a set level.

U.S. Pat. No. 6,189,374 discloses an AFM that combines an AFM Z position actuator and a self-actuated Z position cantilever (both operable in cyclical mode and contact mode), with appropriate nested feedback control circuitry to achieve high-speed imaging and accurate Z position measurements. A preferred embodiment of an AFM for analyzing a surface of a sample includes a self-actuated cantilever having a Z-positioning element integrated therewith and an oscillator that oscillates the self-actuated cantilever at a frequency generally equal to a resonant frequency of the self-actuated cantilever and at an oscillation amplitude generally equal to a setpoint value. The AFM includes a first feedback circuit nested within a second feedback circuit, wherein the first feedback circuit generates a cantilever control signal in response to vertical displacement of the self-actuated cantilever during a scanning operation, and the second feedback circuit is responsive to the cantilever control signal to generate a position control signal. A Z position actuator is also included within the second feedback circuit and is responsive to the position control signal to position the sample. In operation, preferably, the cantilever control signal alone is indicative of the topography of the sample surface.

Non-patent literature (NPL) [1] combines the fast response of photothermal cantilever excitation with a conventional piezoactuator, resulting in a fast force-clamp with high accuracy and large working distances.

NPL [2] applies photothermal bending of a cantilever induced by an intensity-modulated infrared laser to control the tip-surface distance in atomic force microscopy. The slow response of the photothermal expansion effect is eliminated by inverse transfer function compensation. By regulating the laser power and regulating the cantilever deflection, the tip-sample distance is controlled; this enables much faster imaging than that in conventional piezoactuator-based z scanners because of the considerably higher resonant frequency of small cantilevers.

In NPL [3] a flexible system for increasing the throughput of an atomic force microscope without sacrificing imaging range is presented. The system is based on a nested feedback loop which controls a micromachined cantilever that contains both an integrated piezoelectric actuator and an integrated thermal actuator.

NPL [1]: Stahl S W, Puchner E M, Gaub H E. Photothermal cantilever actuation for fast single-molecule force spectroscopy. Rev Sci Instrum. 2009 July; 80(7):073702. doi: 10.1063/1.3157466. PMID: 19655951.

NPL [2]: Yamashita H, Kodera N, Miyagi A, Uchihashi T, Yamamoto D, Ando T. Tip-sample distance control using photothermal actuation of a small cantilever for high-speed atomic force microscopy. Rev Sci Instrum. 2007 August; 78(8):083702. doi: 10.1063/1.2766825. PMID: 17764324.

NPL [3]: T. Sulchek, S. C. Minne, J. D. Adams, D. A. Fletcher, A. Atalar, C. F. Quate, D. M. Adderton; Dual integrated actuators for extended range high speed atomic force microscopy. Appl. Phys. Lett. 13 Sep. 1999; 75 (11): 1637-1639. https://doi.org/10.1063/1.124779.

NPL [4]: Balantekin M, Satir S, Torello D, Değertekin F L. High-speed tapping-mode atomic force microscopy using a Q-controlled regular cantilever acting as the actuator: proof-of-principle experiments. Rev Sci Instrum. 2014 December; 85(12):123705. doi: 10.1063/1.4903469. PMID: 25554299.

NPL [5]: J. Mertz, O. Marti, J. Mlynek; Regulation of a microcantilever response by force feedback. Appl. Phys. Lett. 10 May 1993; 62 (19): 2344-2346. https://doi.org/10.1063/1.109413.

NPL [6]: M. G. Ruppert, B. S. Routley, A. J. Fleming, Y. K. Yong and G. E. Fantner, “Model-based Q Factor Control for Photothermally Excited Microcantilevers,” 2019 International Conference on Manipulation, Automation and Robotics at Small Scales (MARSS), Helsinki, Finland, 2019, pp. 1-6, doi: 10.1109/MARSS.2019.8860969.

### SUMMARY OF THE DISCLOSURE

A first aspect of the invention provides a scanning probe microscope configured to measure a topography of a sample, the scanning probe microscope comprising: a probe mount; a cantilever carried by the probe mount, the cantilever extending from a proximal end at the probe mount to a distal end remote from the probe mount; a probe tip at the distal end of the cantilever; a scanning system configured to generate a relative scanning motion between the probe mount and the sample; a detection system configured to measure the distal end of the cantilever to generate a measurement signal; a signal processor configured to monitor the measurement signal to obtain a series of topography measurements indicative of a topography of the sample; a height actuation system configured to adjust a height of the proximal end of the cantilever by moving the probe mount under control of a height control signal; a photothermal actuation system configured to bend the cantilever by illuminating the cantilever with an actuation beam under control of a photothermal offset signal and an oscillation signal; an oscillation signal generator configured to generate the oscillation signal; and a control system configured to adjust the photothermal offset signal and the height control signal on a basis of the measurement signal.

Optionally the control system is a feedback control system. Alternatively the control system is a feedforward control system. Alternatively the control system may use a combination of feedforward and feedback control, or another control method. Optionally the control system comprises an oscillation error detector configured to monitor the measurement signal to obtain an oscillation parameter and generate an oscillation error signal based on the oscillation parameter and an oscillation parameter setpoint; and the control system is configured to adjust the photothermal offset signal and the height control signal on a basis of the oscillation error signal.

Optionally the control system comprises: a first controller (for example a feedback controller or a feedforward controller) configured to adjust the photothermal offset signal; and a second controller (for example a feedback controller or a feedforward controller) configured to adjust the height control signal.

Optionally the second controller operates at a slower rate than the first controller, or operates with a longer response time than the first controller, or operates with a lower bandwidth than the first controller.

Optionally the first and second controllers operate over non-overlapping frequency bands.

Optionally the control system comprises: a first feedback controller configured to adjust the photothermal offset signal in order to null an input to the first feedback controller; and a second feedback controller configured to adjust the height control signal in order to null an input to the second feedback controller.

Optionally the input to the first feedback controller comprises the oscillation error signal.

Optionally the control system further comprises a photothermal error detector configured to generate a photothermal error signal based on the photothermal offset signal and a photothermal offset setpoint; and the input to the second feedback controller comprises the photothermal error signal.

Optionally the photothermal offset setpoint is at a mid-point of an operating range of the photothermal offset signal.

Optionally the input to the second feedback controller comprises the oscillation error signal.

Optionally the oscillation error signal is fed in parallel to the first and second feedback controllers.

Optionally the photothermal offset signal and the oscillation signal are distinct signals, wherein an intensity of the actuation beam is based on an addition (or other combination) of the photothermal offset signal and the oscillation signal. The photothermal offset signal and oscillation signal may be output by different components: for example, the photothermal offset signal may be output by the first feedback controller and the oscillation signal may be output by the oscillation signal generator.

Optionally the control system is configured to adjust the photothermal offset signal to respond to changes in the topography of the sample.

Optionally the scanning probe microscope further comprises a combiner configured to combine the oscillation signal and the photothermal offset signal to generate a combined signal, wherein the photothermal actuation system is configured to illuminate the cantilever with the actuation beam under control of the combined signal.

Optionally the combiner is an adder which combines the oscillation signal and the photothermal offset signal by adding the oscillation signal and the photothermal offset signal.

Optionally the oscillation signal causes the cantilever to bend in a series of oscillation cycles, and the signal processor is configured to obtain a topography measurement indicative of the topography of the sample for each oscillation cycle.

Optionally the signal processor is configured to extract data from a position within each oscillation cycle that satisfies a predetermined measurement criterion.

Optionally the position within each oscillation cycle is an extremal position.

Optionally the signal processor is configured to monitor the height signal and to derive a measurement for each oscillation cycle that is indicative of the height of the probe.

Optionally the photothermal actuation system has a higher bandwidth than the height actuation system.

Optionally the height actuation system has a larger range of motion (i.e. its full operating range) than the photothermal actuation system. Optionally the height actuation system has a range of motion (i.e. its full operating range) which is more than ten times higher than the photothermal actuation system. For instance the height actuation system may have a full operating range above 5 micron or above 10 micron.

Optionally the oscillation signal is substantially sinusoidal, although the oscillation signal may have a non-sinusoidal waveform such as a triangle waveform or a sawtooth waveform.

The oscillation signal may be at a resonant frequency of the cantilever, or at any other frequency.

The oscillation signal typically varies back and forth in a series of oscillation cycles. The oscillation signal may be periodic so that each oscillation cycle is the same, or it may be aperiodic so that the oscillation cycles vary from cycle to cycle.

Optionally the height actuation system comprises a piezoelectric actuator.

A further aspect of the invention provides a method of measuring a topography of a sample with a scanning probe microscope according to the first aspect, the method comprising: generating a relative scanning motion between the probe mount and the sample with the scanning system; measuring the distal end of the cantilever with the interferometer to generate a measurement signal; monitoring the measurement signal with the signal processor to obtain a series of topography measurements indicative of the topography of the sample; adjusting a height of the proximal end of the cantilever with the height actuation system by moving the probe mount under control of a height control signal; generating an oscillation signal with the oscillation signal generator; bending the cantilever with the photothermal actuation system by illuminating the cantilever with an actuation beam under control of a photothermal offset signal and the oscillation signal; and adjusting the photothermal offset signal and the height control signal with the control system on a basis of the measurement signal.

Optionally the photothermal offset signal is adjusted to respond to changes in the topography of the sample.

Optionally the cantilever is illuminated by separately generating the oscillation signal and the photothermal offset signal; combining the oscillation signal and the photothermal offset signal to generate a combined signal; and illuminating the cantilever with the actuation beam under control of the combined signal.

Optionally combining the oscillation signal and the photothermal offset signal comprises adding the oscillation signal and the photothermal offset signal.

Optionally the photothermal offset signal varies at a lower rate than the oscillation signal.

Optionally the cantilever has a fundamental eigenmode with a fundamental eigenmode frequency, and one or more higher-order eigenmodes each having a frequency higher than the fundamental eigenmode frequency, and the oscillation signal excites one of the higher-order eigenmodes.

Optionally the scanning probe microscope further comprises a Q-control module configured to apply a Q-control signal to the actuation beam to damp oscillation of the cantilever at the fundamental eigenmode frequency.

Optionally the scanning probe microscope further comprises a filter which is configured to filter the measurement signal by passing the frequency of the higher-order eigenmode and blocking the fundamental eigenmode frequency, thereby producing a filtered measurement signal, wherein the photothermal offset signal and the height control signal are adjusted by the control system on a basis of the filtered measurement signal.

Optionally the detection system is an interferometer and the measurement signal is a height measurement signal.

Optionally the detection system is an optical-lever and the measurement signal is a deflection measurement signal.

A further aspect of the invention provides a scanning probe microscope configured to measure a topography of a sample, the scanning probe microscope comprising: a probe mount; a cantilever carried by the probe mount, the cantilever extending from a proximal end at the probe mount to a distal end remote from the probe mount; a probe tip at the distal end of the cantilever; a scanning system configured to generate a relative scanning motion between the probe mount and the sample; a detection system configured to measure the distal end of the cantilever to generate a measurement signal; a signal processor configured to monitor the measurement signal to obtain a series of topography measurements indicative of a topography of the sample; a height actuation system configured to adjust a height of the proximal end of the cantilever by moving the probe mount under control of a height control signal; an actuation system configured to bend the cantilever under control of an oscillation signal; an oscillation signal generator configured to generate the oscillation signal; and a control system configured to adjust the height control signal on a basis of the measurement signal, wherein the cantilever has a fundamental eigenmode with a fundamental eigenmode frequency, and one or more higher-order eigenmodes each having a frequency higher than the fundamental eigenmode frequency, and the oscillation signal excites one of the higher-order eigenmodes.

Optionally the actuation system is a photothermal actuation system configured to bend the cantilever by illuminating the cantilever with an actuation beam under control of the oscillation signal. Alternatively the actuation system may use a piezoelectric actuation element or some other means of bending the cantilever.

Optionally the detection system is an interferometer and the measurement signal is a height measurement signal. Alternatively the detection system is an optical-lever and the measurement signal is a deflection measurement signal.

Optionally the scanning probe microscope further comprises a filter which is configured to filter the measurement signal by passing the frequency of the higher-order eigenmode and blocking the fundamental eigenmode frequency, thereby producing a filtered measurement signal, wherein the height control signal is adjusted by the control system on a basis of the filtered measurement signal.

The height actuation system typically uses a different actuator (which is typically also a different actuator-type) than the actuation system which is configured to bend the cantilever. For instance the height actuation system may use a piezoelectric actuator and the actuation system may use a photothermal actuator.

Optionally the height actuation system has a larger range of motion (i.e. its full operating range) than the actuation system which is configured to bend the cantilever. Optionally the height actuation system has a range of motion (i.e. its full operating range) which is more than ten times higher than the actuation system which is configured to bend the cantilever. For instance the height actuation system may have a full operating range above 5 micron or above 10 micron.

### BRIEF DESCRIPTION OF THE DRAWINGS

Embodiments of the invention will now be described with reference to the accompanying drawings, in which:

FIG. 1 shows a scanning probe microscope according to a first embodiment of the present invention;

FIG. 2 shows a detection system;

FIG. 3 shows a sample topography, with an associated photothermal offset signal and height control signal;

FIG. 4 shows a first comparative example;

FIG. 5 shows a second comparative example;

FIG. 6 shows a third comparative example;

FIG. 7 shows a scanning probe microscope according to a second embodiment of the present invention;

FIG. 8 shows a scanning probe microscope 1e according to a further alternative embodiment of the invention;

FIG. 9 shows a scanning probe microscope 1e according to a further alternative embodiment of the invention; and

FIG. 10 shows a scanning probe microscope 1e according to a further alternative embodiment of the invention.

### DETAILED DESCRIPTION

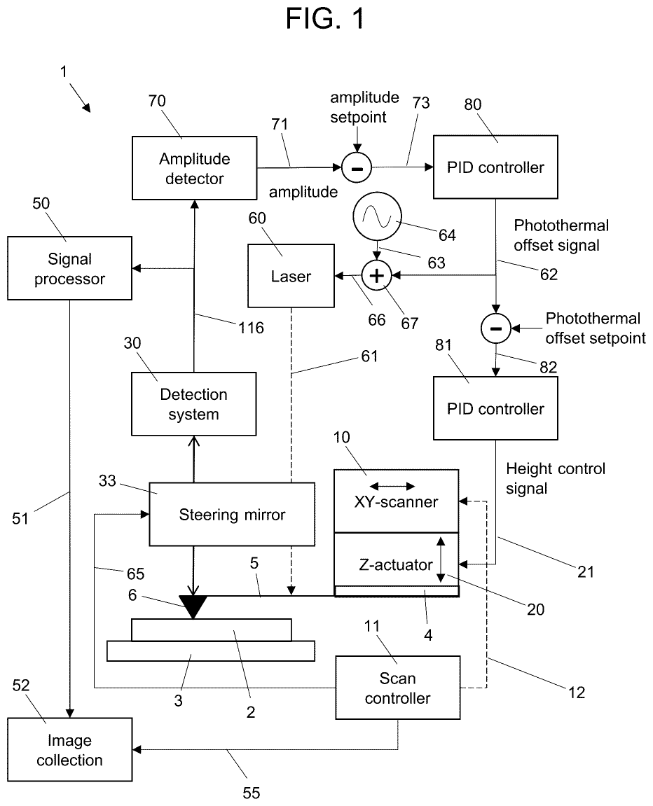

A scanning probe microscope 1 shown in FIG. 1 is configured to measure a topography of a sample 2 on a sample stage 3.

The various functional elements of the microscope shown in FIG. 1 may be implemented in computer software running on one or more computer processors, or in dedicated hardware.

The scanning probe microscope 1 comprises a probe mount 4; and a probe comprising a cantilever 5 and probe tip 6. The cantilever 5 is carried by the probe mount 4, the cantilever 5 extending from a proximal end at the probe mount to a distal end remote from the probe mount. The probe tip 6 is at the distal end of the cantilever 5.

A scanning system 10, 11 is configured to generate a relative scanning motion between the probe mount 4 and the sample 2 in a horizontal (X,Y) plane. In this case the relative scanning motion is achieved by motion of the probe mount 4, but in other embodiments the relative scanning motion may achieved by motion of the sample stage 3.

A height actuation system 20 is configured to adjust a height of the proximal end of the cantilever by moving the probe mount 4 under control of a height control signal 21.

The height actuation system in this case comprises a Z-actuator 20, such a piezoelectric actuator, which is configured to translate the probe mount 4 up and down in an essentially vertical (Z) direction on a basis of the height control signal 21.

The scanning system in this case comprises an XY-scanner 10, such as a pair of piezoelectric actuators which each move the Z-actuator 20 and the probe mount 4 in a respective horizontal direction (X or Y). The XY-scanner 10 is driven by scanning drive signals 12 from a scan controller 11.

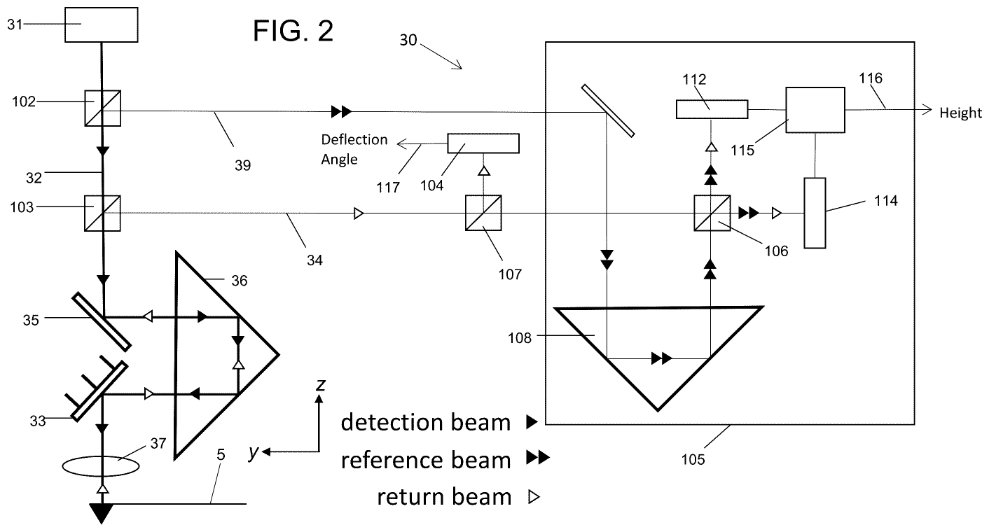

A detection system 30 is shown schematically in FIG. 1 and in further detail in FIG. 2.

A laser light source 31 generates a detection beam 32 which is steered onto the distal end of the cantilever 5 by a steering mirror 33. The distal end of the cantilever 5 reflects the detection beam 32 to generate a return beam 34.

The detection beam 32 is reflected from a fixed mirror 35 towards a right-angle block 36. The right angle block 36 is oriented such that the detection beam 32 is incident normally on the entry face. The detection beam 32 propagates to the steering mirror 33 and is reflected towards an objective lens 37. As the steering mirror 33 tilts, the reflected detection beam 32 deflects, with the result that the angle and point of incidence of the detection beam 32 into the objective lens 37 changes. Synchronisation of the angle of the steering mirror 33 with the XY scanning pattern followed by the probe mount 4 as it is driven by the XY scanner 10 means that the detection beam 32 retains its position on the distal end of the cantilever 5.

The light from the laser light source 31 is split by a beam splitter 102 into the detection beam 32 and a reference beam 39. The return beam 34 is directed into the detection system 30 by a second beam splitter 103. The return beam 34 is then split by a third beam splitter 107 into a first component which falls on a split photodiode 104, and a second component which is directed into an interferometer 105.

The split photodiode 104 is a position sensitive detector which generates a deflection measurement signal 117 in accordance with an offset of the first component of the return beam 34 relative to the split photodiode 104. The deflection measurement signal 117 is indicative of a deflection angle of the cantilever. Typically the split photodiode 104 is split into four quadrants, the ratios between the signals from the four quadrants indicating offsets in X and Y of the first component of the return beam 34 relative to the split photodiode 104.

Inside the interferometer 105, the second component of the return beam 34 is split by a beam splitter 106. The reference beam 39 is directed onto a retroreflector 108 and thereafter to the beam splitter 106. The beam splitter 106 has an energy absorbing coating and splits both the return beam 34 and the reference beam 39 to produce first and second interferograms with a relative phase shift of ˜90°. The two interferograms are detected respectively at photodetectors 112, 114.

Ideally, the photodetector signals are complementary sine and cosine signals with a phase difference of 90°. Further, they should have no dc offset, have equal amplitudes and only depend on the position of the cantilever and wavelength λ of the laser. Known methods are used to monitor the outputs of the photodetectors 112, 114 while changing the optical path difference in order to determine and to apply corrections for errors arising as a result of the two photodetector signals not being perfectly harmonic, with equal amplitude and in phase quadrature. Similarly, dc offset levels are also corrected in accordance with methods known in the art.

These photodetector signals are suitable for use with a conventional interferometer reversible fringe counting apparatus and fringe subdividing apparatus, which may be provided as dedicated hardware or as a programmed computer. Phase quadrature fringe counting apparatus is capable of measuring displacements in the position of the cantilever to an accuracy of λ/8. That is, to 66 nm for light with a wavelength of 532. Known fringe subdividing techniques, based on the arc tangent of the signals, permits an improvement in accuracy to the nanometre scale or less. Interferometric methods of extracting the path difference between two coherent beams are well known in the art and so will not be described in any further detail. In FIG. 2 a processor 115 is shown which receives the signals from the photodetectors 112, 114 and performs the fringe counting and subdividing mentioned above to generate a height measurement signal 116.

In summary, the interferometer 105 is arranged to detect a path difference between light 34 reflected from the distal end of the cantilever and a height reference beam 39. The height measurement signal 116 is indicative of this path difference, and hence indicative of a height of the distal end of the cantilever 5.

Returning to FIG. 1: a signal processor 50 is configured to monitor the height measurement signal 116 to obtain a series of topography measurements indicative of a topography of the sample. These topography measurements may be output as a topography measurement signal 51 to an image collection module 52.

A photothermal actuation system 60, such as a laser, is configured to bend the cantilever 5 by illuminating the cantilever with an actuation beam 61 under control of a photothermal offset signal 62 and an oscillation signal 63. An oscillation signal generator 64 is configured to generate the oscillation signal 63. The oscillation signal 63 may be substantially sinusoidal, at a resonant frequency of the cantilever 5. Typically the resonant frequency of the cantilever is a few hundred kHz but it can be over 1 MHz.

The cantilever 5 has a fundamental eigenmode with a fundamental eigenmode frequency (denoted f1) and one or more higher-order eigenmodes each having a frequency (denoted f2, f3 etc) higher than the fundamental eigenmode frequency f1. Typically the oscillation signal 63 in the scanning probe microscope 1 of FIG. 1 excites the fundamental eigenmode, but in other embodiments the oscillation signal 63 may excite one of the higher-order eigenmodes.

The oscillation signal 63 may be a periodic signal which repeats at regular intervals, typically at a frequency higher than 1 MHz. The photothermal offset signal 62 may be an aperiodic signal, separate from the oscillation signal 63, which is adjusted to respond to changes in the topography of the sample. Typically the photothermal offset signal 62 varies at a lower rate than the oscillation signal 63, i.e. at a frequency lower than the resonant frequency of the cantilever 5.

In this example the oscillation signal 63 is substantially sinusoidal, but in other embodiments the oscillation signal 63 may have a non-sinusoidal waveform such as a triangle waveform or a sawtooth waveform.

The oscillation signal 63 varies back and forth in a series of oscillation cycles. Each oscillation cycle may be the same, or the oscillation cycles may vary from cycle to cycle (for instance with different periods from cycle to cycle).

In general terms the oscillation signal 63 is typically an AC signal (which typically varies continuously) whereas the photothermal offset signal 62 is typically a DC signal (which is either constant, or varying slowly).

The cantilever 5 is illuminated by separately generating the oscillation signal 63 and the photothermal offset signal 62; combining the oscillation signal and the photothermal offset signal to generate a combined signal 66; and illuminating the cantilever with the actuation beam 61 under control of the combined signal 66. That is, the photothermal actuation system 60 adjusts the intensity of the actuation beam 61 on a basis of the combined signal 66.

In this example the oscillation signal 63 and the photothermal offset signal 63 are combined by adding them together at an adder 67. Alternatively the oscillation signal 63 and the photothermal offset signal 62 may be combined by a different type of combiner.

A feedback control system, described in detail below, is configured to generate the photothermal offset signal 62 as a separate signal from the oscillation signal 63.

The cantilever 5 has a thermal bimorph structure, the materials of which undergo differential expansion when heated. In one embodiment, the cantilever 5 is fabricated from silicon nitride with an aluminium coating. The photothermal actuation system 60 comprises a laser which emits the actuation beam 61 which contains light at a wavelength at which there is a maximum or peak in the absorption spectrum for the particular coating. For example the wavelength may be around the aluminium absorption peak at ˜810 nm. Other coating/wavelength combinations can be used, for example gold has a higher absorption at wavelengths below 500 nm. When this light is incident on the coating side of the cantilever 5, the aluminium expands to a greater degree than the silicon nitride, bending the cantilever such that the tip moves downwards, towards the sample. If illumination intensity is increased, the tip therefore moves closer to the sample surface. Conversely, if the intensity is lowered, bending is decreased and the tip is moved away from the sample. Other arrangements of coating and base materials may result in different levels of bending in the same or opposite direction in response to illumination.

As explained above, the detection beam 32 of FIG. 2 is directed onto the cantilever by a steering mirror 33 and an objective lens 37. As the steering mirror 33 tilts, the reflected detection beam 32 deflects and retains its position on the distal end of the cantilever 5.

The actuation beam 61 is also directed onto the cantilever by the steering mirror 33 and the objective lens 37. As the steering mirror 33 tilts, the actuation beam 61 deflects and retains its position on the cantilever 5 (in this case towards the proximal end of the cantilever).

Thus the steering mirror 33 retains the positions of both beams 32, 61 on the cantilever 5. The steering mirror 33 is driven by steering signals 65 from the scan controller 11.

A feedback control system 70, 80, 81 is configured to adjust the photothermal offset signal 62 and the height control signal 21 on a basis of the height measurement signal 116, so that the probe tip follows the topography of the sample 2.

The feedback control system comprises an oscillation error detector configured to monitor the height measurement signal 116 to obtain an oscillation parameter 71 and generate an oscillation error signal 73 based on the oscillation parameter and an oscillation parameter setpoint.

In this example, the oscillation parameter is an amplitude 71 measured by an amplitude detector 70, and the oscillation parameter setpoint is an amplitude setpoint. In other examples the oscillation parameter may be a phase or frequency

The amplitude setpoint is subtracted from the amplitude 71 to generate the oscillation error signal, which in this case is an amplitude error signal 73. The feedback control system is configured to adjust the height control signal 21 and the photothermal offset signal 62 on a basis of this amplitude error signal 73, as described below.

The feedback control system comprises a first feedback controller 80 configured to adjust the photothermal offset signal 62 in order to null an input to the first feedback controller 80.

In this embodiment, the input to the first feedback controller 80 comprises the amplitude error signal 73. Hence the first feedback controller 80 is configured to adjust the photothermal offset signal 62 so that the amplitude 71 remains at the amplitude setpoint. As a result, the photothermal offset signal 62 reacts to changes in the topography of the sample when a feature of the sample results in the amplitude error signal 73 having a non-zero value.

By way of example, the first feedback controller 80 may comprise a proportional-integral (PI) feedback controller or a proportional-integral-differential (PID) feedback controller.

A second feedback controller 81 is configured to adjust the height control signal 21 in order to null an input to the second feedback controller 81.

The feedback control system comprises a photothermal error detector configured to generate a photothermal error signal 82 based on the photothermal offset signal 62 and a photothermal offset setpoint; and the input to the second feedback controller 81 comprises this photothermal error signal 82.

The photothermal offset setpoint may be subtracted from the photothermal offset signal 62 to generate the photothermal error signal 82. The photothermal offset setpoint may be set at a mid-point of an operating range of the photothermal offset signal 62. Hence the second feedback controller 81 is configured to adjust the height control signal 21 so that the photothermal offset signal 62 remains at the mid-point of its operating range.

In taking an image of the sample, the scanning probe microscope is operated in dynamic mode as follows. The cantilever 5 is set into resonant oscillatory motion by the oscillation signal generator 64. Using the Z-actuator 20, the probe tip 6 is first brought into intermittent contact with the sample 2. Conventionally, in AFM terminology, the probe tip 6 is said to be in contact with the sample 2 when the atomic interaction force is in the repulsive regime. The probe mount 4 is lowered, moving the probe tip towards the sample 1 whilst, in this embodiment, the detection system 30 monitors the oscillating and time-varying deflection of the cantilever. When the amplitude of deflection oscillation reaches a predetermined level the movement of the probe mount 4 is stopped. This predetermined amplitude level is the amplitude setpoint for the feedback controller 80.

As the scan progresses, the probe tip 6 moves up and down as surface height/interaction force varies. Superimposed on this surface-induced motion is a higher frequency component arising from the oscillatory motion of the cantilever driven by the oscillation signal 63. The amplitude, phase and frequency of this oscillatory component of the probe tip's motion will all be dependent on both the oscillator settings and the interaction force between surface and probe tip. Similarly, the height of the probe tip is a superposition of a component arising from interaction with the sample surface and a second component due to probe oscillations. The amplitude, phase and frequency of the second component are affected by the probe tip's position with respect to the surface. As the scan progresses, the amplitude of the ac component of the height measurement signal 116 is monitored.

It will be appreciated that the height measurement signal 116 contains accurate information relating to the height of the probe tip, but this must be related to features of the sample surface in order for useful information to be obtained. In theory, the lowest point of each oscillation cycle represents the true height of the surface. Accordingly the signal processor 50 may be set up in order to be able to find the lowest height measurement for each period of probe oscillation and this is then output as a topography measurement signal 51 that can be used by the image collection module 52 to form an image. That is, the lowest point in each oscillation cycle is representative of the position of the sample surface.

Other points of the high-frequency oscillation component of the signal may also be used to provide a meaningful indicator of sample surface position. For example, the point of minimum velocity during the lower half of the oscillation cycle may be extracted by the data processing system. If imaging a compliant surface then the probe velocity, or equivalently rate of change of the height signal, will fall as it encounters and begins to deforms the surface. In this instance a measure of sample height may be extracted from the point of each height oscillation at which a variation in the rate of change of probe height is observed.

The signal processer 50 is preferably arranged to extract data from a position within each oscillation cycle of the height measurement signal 116 that satisfies a predetermined measurement criterion. This may be when the cycle indicates an extremal path difference, a minimum rate of change in path difference, or another suitable indicator. This ensures that the measurement point is extracted at a position most likely to reflect the true height of the sample. For example, at a minimum (or maximum) path difference it can be inferred that the probe tip is in contact with the sample surface. This improves the accuracy of information extracted by the detection system 30, which may then be used by the image collection module 52 to generate an image of the sample surface. This image may reflect surface height, or any other aspect of the topography of the sample.

Alternatively, the signal processer 50 could use an average of the height measurement signal 116 to generate the topography measurement signal 51 which is used by the image collection module 52 to form an image.

In this example, an image collection module 52 constructs an image on the basis of the topography measurement signal 51, and an XY position signal 55 from the scan controller 11 which indicates the current XY position of the probe tip.

In other embodiments of the invention, rather than generating an image with an image collection module 52, the scanning probe microscope 1 may use the topography measurement signal 51 in some other way—for instance to measure a critical dimension of the sample (such as a wall height, wall angle, trench width, etc.). In this case a series of topography measurements may be measured with only a single line scan (for instance across a trench) rather than scanning in two-dimensions to generate a topographical image.

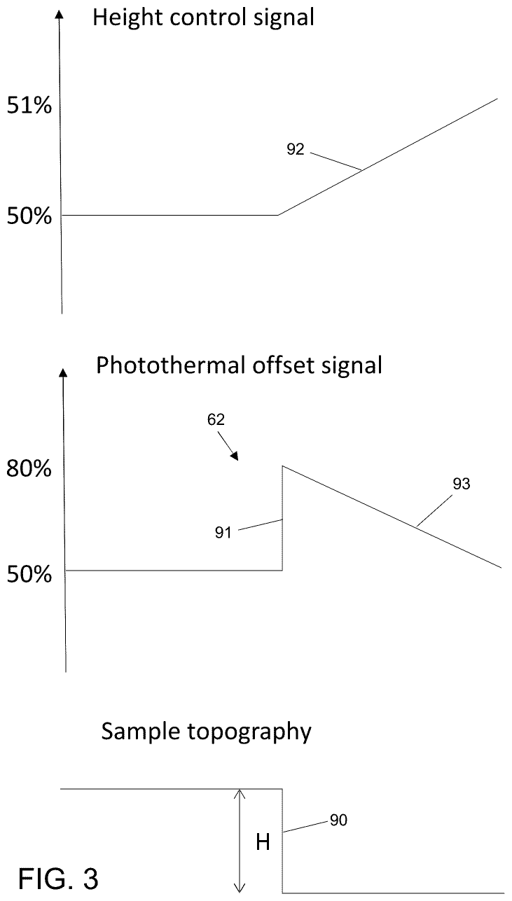

FIG. 3 gives an example of a topography of the surface of the sample 2. In this case, the surface of the sample has a steep sidewall 90 with a height H. Sidewalls of this type are common in semiconductor samples, for instance at a sidewall of a trench or other feature.

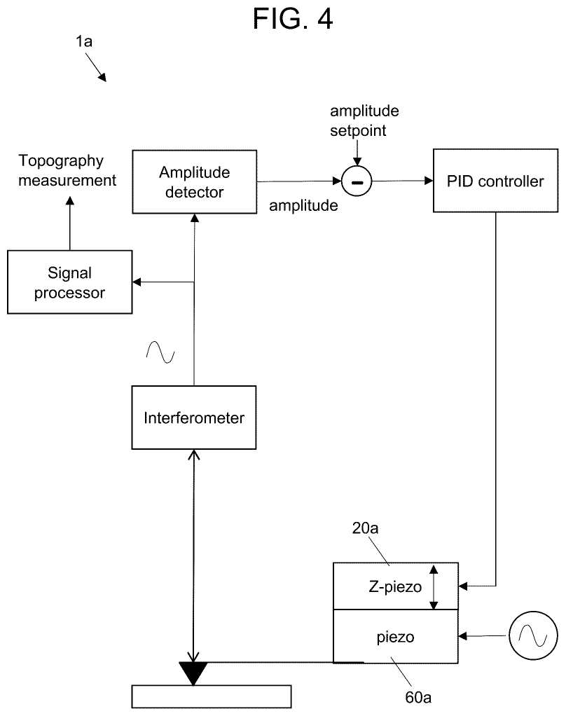

FIG. 4 shows a scanning probe microscope 1a according to a comparative example, not according to the present invention. In this case, the resonant oscillation is driven by a piezoelectric actuator 60a rather than the photothermal actuation system 60 of FIG. 2. A height actuation system 20a, similar to the Z-actuator 20 of FIG. 2, is configured to adjust a height of the proximal end of the cantilever by moving the probe mount under control of a height control signal from a PID controller. The scanning probe microscope 1a is similar to the scanning probe microscope described in WO2010067129A1.

A first problem with the scanning probe microscope 1a of FIG. 4 is that the piezoelectric actuator 60a has a low bandwidth. As a consequence, in order to accurately image the steep sidewall 90, the probe must be scanned slowly in the XY plane. Slow scan rates are particularly problematic in the analysis of semiconductor samples, for instance for process monitoring and control in a semiconductor fabrication plant or other high volume manufacturing facility.

A second problem is that the piezoelectric actuator 60a may respond to the oscillation signal with its own resonances, which can cause undesirable characteristics in the oscillation of the cantilever.

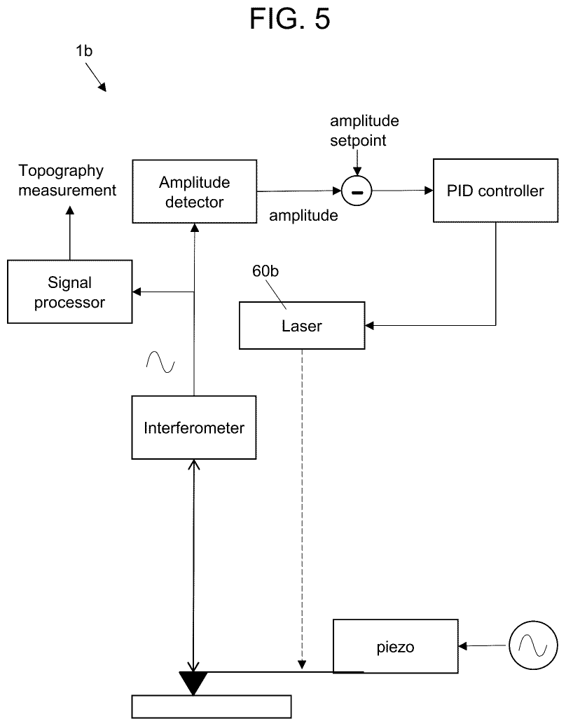

FIG. 5 shows a scanning probe microscope 1b according to a second comparative example, not according to the present invention. In this case the vertical motion of the probe is driven photothermally by a laser 60b which has a higher bandwidth than the piezoelectric actuator 60a (typically by a factor of 10 or more or by a factor of 100 or more) and hence can drive the probe tip down more rapidly to the bottom of the sidewall 90.

A problem with the scanning probe microscope 1b of FIG. 5 is that the photothermal actuation system 60b has a small range, which may be less than the height H of the sidewall 90. The scanning probe microscope 1b of FIG. 5 also suffers from the problem of undesirable resonances in the piezoelectric actuator.

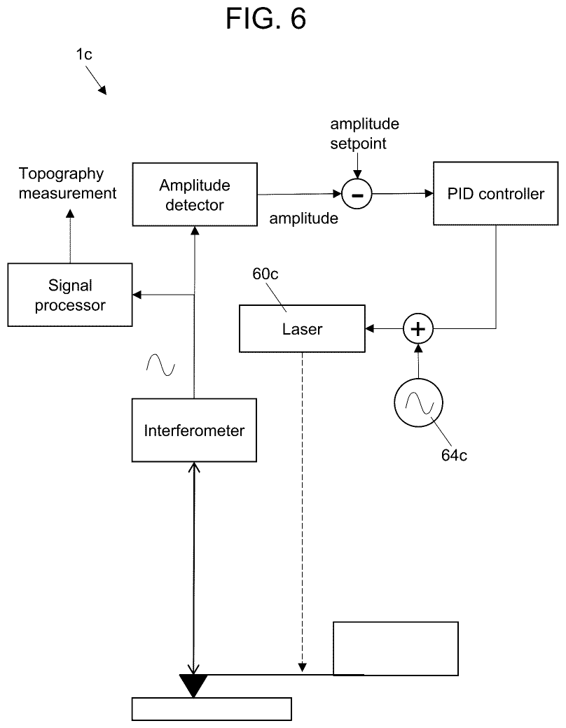

FIG. 6 shows a scanning probe microscope 1c according to a third comparative example, not according to the present invention.

In this case a photothermal actuator 60c drives both the oscillation of the probe (via an oscillation signal from an oscillation signal generator 64c) and the DC offset of the probe, following the profile of the sample.

The scanning probe microscope 1c of FIG. 6 has the same range problem as scanning probe microscope 1b of FIG. 5 but does has various advantages over the scanning probe microscope 1b, namely: the number of actuators is reduced (one actuator rather than two); and the direct drive of the cantilever results in a cleaner excitation of the cantilever, avoiding the undesirable oscillation characteristics caused by the piezoelectric actuator 60a.

The range problem could be solved by increasing the length of the cantilever, but this would increase its thermal mass which in turn would make it respond more slowly to photothermal heating (in other words, it would reduce the bandwidth of the photothermal actuation system).

The scanning probe microscope 1 of FIG. 1 includes the advantages of the scanning probe microscope 1c of FIG. 6 but addresses the range problem without reducing the bandwidth.

FIG. 3 shows the photothermal offset signal 62 as the probe scans across the sidewall 90, from left to right. As the probe reaches the sidewall 90, the photothermal offset signal 62 rapidly jumps at step 91 from 50% to 80%. The percentages indicate the amount of the full range of the photothermal actuation system: i.e. at 0% the cantilever 5 is unbent and at 100% the cantilever 5 is fully bent down. So in this example the height H of the sidewall represents 30% of the dynamic range of the photothermal actuation system. The full range is typically less than 1 micron, for instance approximately 100 nm.

The Z-actuator 20 has a low bandwidth, so it can only react slowly to the sudden change of height at the sidewall 90. Hence the height control signal 21 gradually increases from 50% to 51% in an up-ramp 92. The percentages indicate the amount of the full range of the Z-actuator 20: i.e. at 0% the Z-actuator 20 is un-extended and at 100% the Z-actuator 20 is fully extended. In this example the height H of the sidewall represents only 1% of the dynamic range of the Z-actuator 20. The full range is typically of the order of 10-15 micron, i.e. more than ten times greater than the range of the photothermal actuation system.

As the height control signal 21 gradually increases from 50% to 51% in the up-ramp 92, the first feedback controller 80 causes the photothermal offset signal 62 to gradually reduce via a down-ramp 93, counteracting the up-ramp 92, until the photothermal offset signal 62 returns to its setpoint (in this case, 50%). Hence the feedback control system of the scanning probe microscope 1 addresses the range problem by ensuring that the photothermal offset signal 62 remains close to its setpoint.

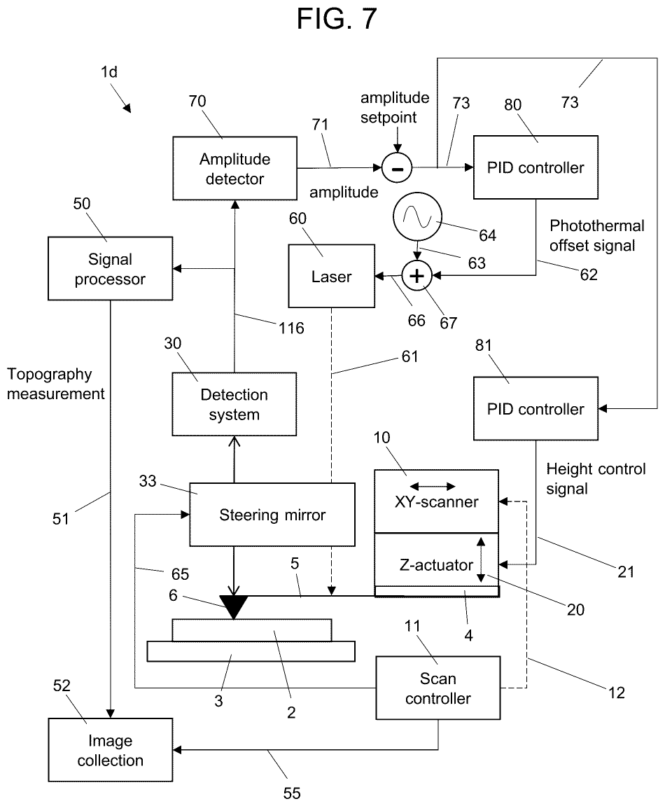

FIG. 7 shows a scanning probe microscope 1d according to an alternative embodiment of the invention. Most elements of the scanning probe microscope 1d are identical to the scanning probe microscope 1 of FIG. 1, and these elements are given the same reference number.

In the scanning probe microscope 1d, the input to the second feedback controller 81 comprises the amplitude error signal 73, which is fed in parallel to the first and second feedback controllers 80, 81. In the scanning probe microscope 1d, the second feedback controller 81 operates at a slower rate than the first feedback controller 80.

Operating the second feedback controller 81 at a lower rate than the first feedback controller 80 (or equivalently with a longer response time or a lower bandwidth) avoids unwanted interaction between the controllers 80, 81.

A preferred way of avoiding unwanted interaction between the feedback controllers 80, 81 is for them to operate over non-overlapping frequency bands. For example the second feedback controller 81 may operate over a band of DC up to 1 kHz, and the first feedback controller 80 may operate over a band from a few kHz to several MHz.

Another way of avoiding unwanted interaction between the controllers 80, 81 is for them to operate by different control methods. For example the second feedback controller 81 may be replaced by a feedforward controller.

In the alternative embodiment shown in FIG. 7, the second feedback controller 81 receives the amplitude error signal 73 and processes this signal to provide the height control signal 21. Therefore this embodiment does not require the photothermal offset signal 62 to be input into the second feedback controller 81. The advantage of this embodiment is that the height control signal 21 is generated based more directly on the amplitude error signal 73, which in turn is directly derived from the height measurement signal 116. Also, the height control signal 21 is generated without using the first feedback controller 80, so the system is more robust.

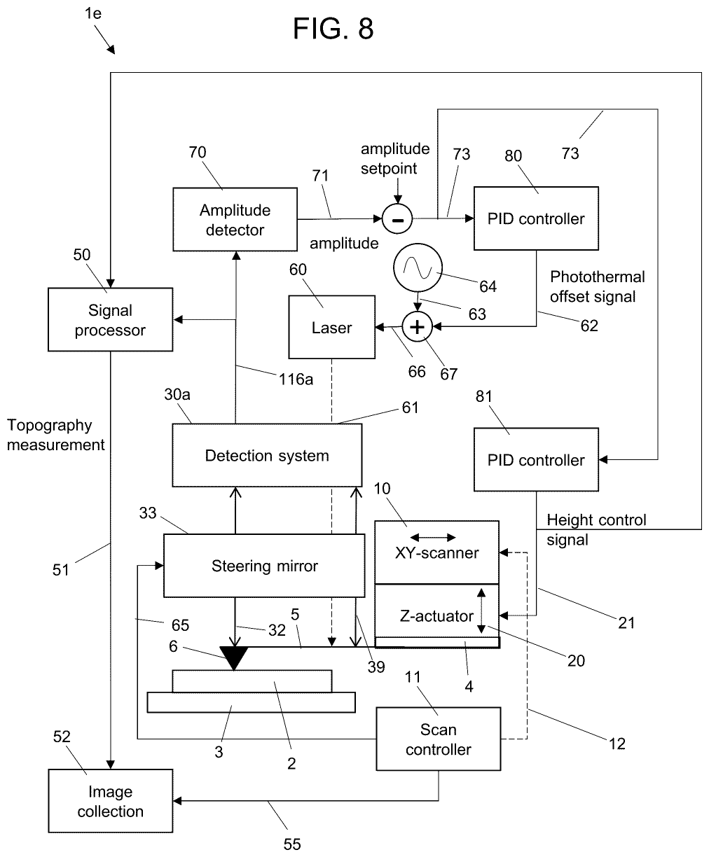

FIG. 8 shows a scanning probe microscope 1e according to a further alternative embodiment of the invention. Most elements of the scanning probe microscope 1e are identical to the scanning probe microscope 1d of FIG. 7, and these elements are given the same reference number.

In FIG. 8, the detection system 30a comprises a differential interferometer which is similar to the interferometer 105 of FIG. 2 in that it illuminates the probe with a detection beam 32 which is steered onto the distal end of the cantilever 5 by a steering mirror 33. In this case the reference beam 39 is steered onto the proximal end of the cantilever 5 (or onto the probe mount 4) by the steering mirror 33 to generate a reflected reference return beam which is combined with the reflected detection return beam from the distal end of the cantilever. Hence the differential interferometer generates an output which indicates the height difference between the proximal end of the cantilever 5 (or the probe mount 4) and the distal end of the cantilever. So the output of the detection system 30a is a signal 116a which is indicative of a height of the distal end of the cantilever (relative to the proximal end rather than a fixed reference frame), and is also indicative of probe deflection.

The signal 116a from the detection system 30a is combined with the height control signal 21 at the signal processor 50 to determine the sample height and hence provide a topography measurement.

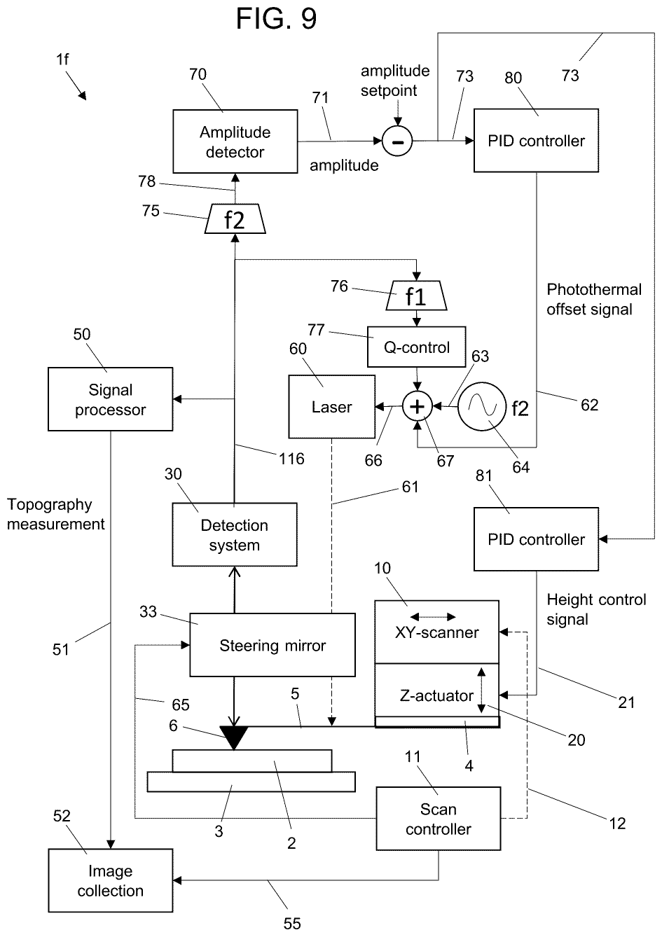

FIG. 9 shows a scanning probe microscope 1f according to a further alternative embodiment of the invention. Most elements of the scanning probe microscope 1f are identical to the scanning probe microscope 1d of FIG. 7, and these elements are given the same reference number.

The cantilever 5 has a fundamental eigenmode with a fundamental eigenmode frequency (denoted f1) and one or more higher-order eigenmodes each having a frequency (denoted f2, f3 etc) higher than the fundamental eigenmode frequency. In the previous embodiments, the oscillation signal 63 excites the fundamental eigenmode. In the case of FIG. 9, the oscillation signal 63 excites one of the higher-order eigenmodes, in this case the second eigenmode (with a frequency denoted f2). Hence the oscillation signal 63 is a sinusoidal signal with a frequency f2.

FIG. 9 also incorporates a bandpass filter 75 which is tuned to pass the frequency f2 of the higher-order eigenmode and block other frequencies (including the frequency f1 of the fundamental eigenmode); and a bandpass filter 76 which is tuned to pass the frequency f1 of the fundamental eigenmode and block other frequencies (including the frequency f2 of the higher-order eigenmode).

A Q-control module 77 applies a Q-control signal to the combined signal 66 to damp oscillation of the cantilever 5 at the frequency f1 of the fundamental eigenmode. The Q-control signal is based on the bandpass filtered height measurement signal output by the bandpass filter 76, with an appropriately adjusted phase and gain.

The Q-control module 77 may damp oscillation of the cantilever using a similar method to the Q-control method implemented in NPL [5] (Balantekin et al). Note that NPL [5] applies Q-control to a regular cantilever which is not photothermally actuated. Alternative methods of Q-control which may be implemented by the Q-control module 77 are described in NPL [6] (Mertz et al) and NPL [7] (Ruppert et al). NPL [6] and NPL [7] apply Q-control to a photothermally actuated cantilever.

The oscillation signal generator 64 in FIG. 9 is configured to generate and output the oscillation signal 63 at the frequency f2, so it excites oscillation of the cantilever according to the second eigenmode.

The bandpass filter 75 is configured to filter the measurement signal by passing the frequency f2 of the higher-order eigenmode and blocking the frequency f1 of the fundamental eigenmode, thereby producing a filtered measurement signal 78. The amplitude detector 70 receives this filtered measurement signal 78 as an input, so the photothermal offset signal 62 and the height control signal 21 are both adjusted by the control system on a basis of the filtered measurement signal 78.

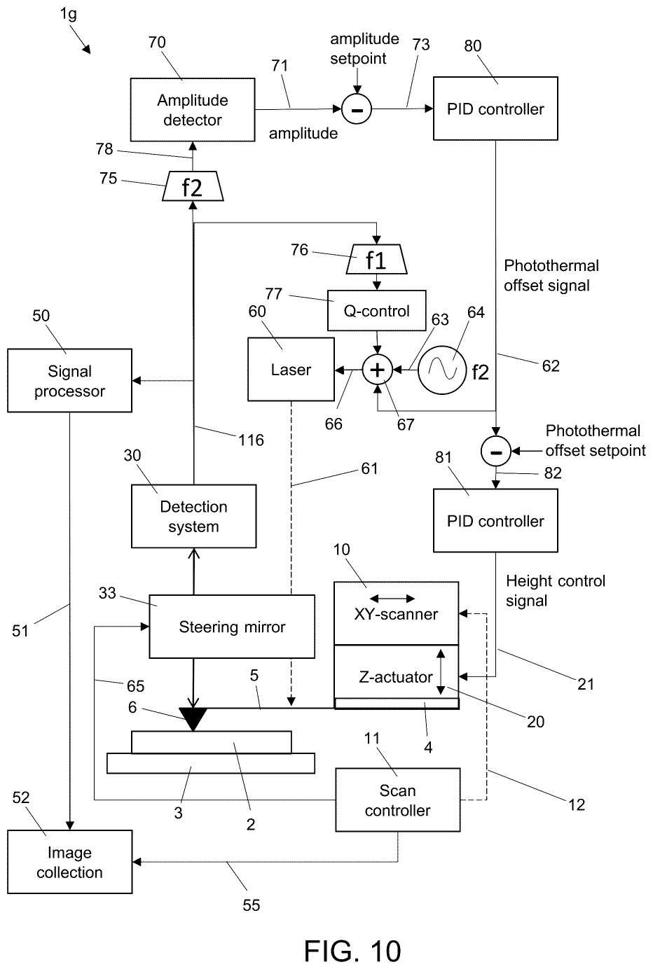

FIG. 10 shows a scanning probe microscope 1g according to a further alternative embodiment of the invention. Most elements of the scanning probe microscope 1 are identical to the scanning probe microscope 1 of FIG. 1, and these elements are given the same reference number. Other elements of the scanning probe microscope 1g are identical to the scanning probe microscope 1f of FIG. 9, and again these elements are given the same reference number.

In FIG. 10 (as in FIG. 1) the microscope has a nested feedback arrangement in which the output of the PID controller 80 feeds into the PID controller 81. As in FIG. 9, the oscillation signal 63 excites one of the higher-order eigenmodes, in this case the second eigenmode (with a frequency denoted f2).

The principal of FIG. 9 or FIG. 10 may be extended further such that the oscillation signal 63 excites an even higher-order eigenmode, such as the third eigenmode, the fourth eigenmode, etc. In this case the frequency of the bandpass filter 75 is adapted accordingly to match the frequency of the higher-order eigenmode, and one or more further Q-control modules are added so that each lower eigenmode is damped for the purpose of Q-control. Thus, for example, if the oscillation signal 63 excites the third eigenmode (frequency f3) then a second (f2) Q-control module and bandpass filter are added so that two Q-control signals (at frequencies f1 and f2) are applied to the combined signal 66.

In summary, the embodiments of the present invention described above provide a feedback control system comprising a pair of feedback controllers 80, 81 each configured to adjust a photothermal offset signal and a height control signal on a basis of a respective input which is derived (directly or indirectly) from a height measurement signal 116, 116a. The first feedback controller 80 may be configured to adjust the photothermal offset signal on a basis of an oscillation error signal which is derived directly from the height measurement signal 116, 116a. The second feedback controller 81 may be configured to adjust the height control signal on a basis of either a photothermal error signal (which is derived indirectly from the height measurement signal 116, 116a) or on a basis of the oscillation error signal (which is derived directly from the height measurement signal 116, 116a).

In other embodiments of the invention (not shown) the first feedback controller 80 could be replaced by a first feedforward controller which uses feedforward information from a previous line scan combined with feedback from the amplitude or sample interaction signal. The second feedback controller 81 could be replaced by a second feedforward controller which completely operates on feedforward information from the previous scan line or a combination.

In the embodiments above, the detection system 30 comprises an interferometer 105 shown in FIG. 2, which is configured to measure a height of the distal end of the cantilever 5 to generate a height measurement signal 116. This height measurement signal 116 is used to obtain the topography measurements and to control the actuation system. That is, the signal processor 50 is configured to monitor the height measurement signal 116 to obtain a series of topography measurements indicative of a topography of the sample; and the control system 80, 81 is configured to adjust the photothermal offset signal 62 and the height control signal 21 on a basis of the height measurement signal 116.

In the cases of FIGS. 1, 7, 9 and 10 an alternative type of detection system (such as an optical lever) may be used instead which does not use interferometry to measure the distal end of the cantilever, but generates a measurement signal in a different way.

The detection system 30 of FIG. 2 incorporates an optical lever-based detection system which reflects a detection beam off the distal end of the cantilever and then directs the reflected beam onto a split photodiode 104. The optical lever measures the deflection angle of the distal end of the cantilever, rather than directly measuring its height.

In these alternative embodiments, the deflection measurement signal 117 may be used in a similar way to the height measurement signal 116. Hence (for example) the signal processor 50 may be configured to monitor the deflection measurement signal 117 to obtain a series of topography measurements indicative of a topography of the sample; and the control system 80, 81 may be configured to adjust the photothermal offset signal 62 and the height control signal 21 on a basis of the deflection measurement signal 117.

Although the invention has been described above with reference to one or more preferred embodiments, it will be appreciated that various changes or modifications may be made without departing from the scope of the invention as defined in the appended claims.

1. A scanning probe microscope configured to measure a topography of a sample, the scanning probe microscope comprising: a probe mount; a cantilever carried by the probe mount, the cantilever extending from a proximal end at the probe mount to a distal end remote from the probe mount; a probe tip at the distal end of the cantilever; a scanning system configured to generate a relative scanning motion between the probe mount and the sample; a detection system configured to measure the distal end of the cantilever to generate a measurement signal; a signal processor configured to monitor the measurement signal to obtain a series of topography measurements indicative of a topography of the sample; a height actuation system configured to adjust a height of the proximal end of the cantilever by moving the probe mount under control of a height control signal; a photothermal actuation system configured to bend the cantilever by illuminating the cantilever with an actuation beam under control of a photothermal offset signal and an oscillation signal; an oscillation signal generator configured to generate the oscillation signal; and a control system configured to adjust the photothermal offset signal and the height control signal on a basis of the measurement signal.

2. A scanning probe microscope according to claim 1 wherein the control system comprises an oscillation error detector configured to monitor the measurement signal to obtain an oscillation parameter and generate an oscillation error signal based on the oscillation parameter and an oscillation parameter setpoint; and wherein the control system is configured to adjust the photothermal offset signal and the height control signal on a basis of the oscillation error signal.

3. A scanning probe microscope according to any claim 1, wherein the control system comprises: a first feedback controller configured to adjust the photothermal offset signal in order to null an input to the first feedback controller; and a second feedback controller configured to adjust the height control signal in order to null an input to the second feedback controller.

4. A scanning probe microscope according to claim 2, wherein the control system comprises: a first feedback controller configured to adjust the photothermal offset signal in order to null an input to the first feedback controller; and a second feedback controller configured to adjust the height control signal in order to null an input to the second feedback controller, wherein the input to the first feedback controller comprises the oscillation error signal.

5. A scanning probe microscope according to claim 3, wherein the control system further comprises a photothermal error detector configured to generate a photothermal error signal based on the photothermal offset signal and a photothermal offset setpoint; and the input to the second feedback controller comprises the photothermal error signal.

6. A scanning probe microscope according to claim 5, wherein the photothermal offset setpoint is at a mid-point of an operating range of the photothermal offset signal.

7. A scanning probe microscope according to claim 2, wherein the control system comprises: a first feedback controller configured to adjust the photothermal offset signal in order to null an input to the first feedback controller; and a second feedback controller configured to adjust the height control signal in order to null an input to the second feedback controller, wherein the input to the second feedback controller comprises the oscillation error signal.

8. A scanning probe microscope according to claim 4, wherein the input to the second feedback controller comprises the oscillation error signal.

9. A scanning probe microscope according to claim 1, wherein the oscillation signal causes the cantilever to bend in a series of oscillation cycles, and the signal processor is configured to obtain a topography measurement indicative of the topography of the sample for each oscillation cycle.

10. A scanning probe microscope according to claim 1, wherein the signal processor is configured to monitor the height signal and to derive a measurement for each oscillation cycle that is indicative of the height of the probe.

11. A scanning probe microscope according to claim 1, wherein the photothermal actuation system has a higher bandwidth than the height actuation system.

12. A scanning probe microscope according to claim 1, wherein the height actuation system has a larger range of motion than the photothermal actuation system.

13. A scanning probe microscope according to claim 1, wherein the control system comprises: a first controller configured to adjust the photothermal offset signal; and a second controller configured to adjust the height control signal.

14. A scanning probe microscope according to claim 1, wherein the control system is configured to adjust the photothermal offset signal to respond to changes in the topography of the sample.

15. A scanning probe microscope according to claim 1, further comprising a combiner configured to combine the oscillation signal and the photothermal offset signal to generate a combined signal, wherein the photothermal actuation system is configured to illuminate the cantilever with the actuation beam under control of the combined signal.

16. A method of measuring a topography of a sample with a scanning probe microscope according to claim 1, the method comprising: generating a relative scanning motion between the probe mount and the sample with the scanning system; measuring the distal end of the cantilever with the interferometer to generate a measurement signal; monitoring the measurement signal with the signal processor to obtain a series of topography measurements indicative of the topography of the sample; adjusting a height of the proximal end of the cantilever with the height actuation system by moving the probe mount under control of a height control signal; generating an oscillation signal with the oscillation signal generator; bending the cantilever with the photothermal actuation system by illuminating the cantilever with an actuation beam under control of a photothermal offset signal and the oscillation signal; and adjusting the photothermal offset signal and the height control signal with the control system on a basis of the measurement signal.

17. A method according to claim 16, wherein the cantilever has a fundamental eigenmode with a fundamental eigenmode frequency, and one or more higher-order eigenmodes each having a frequency higher than the fundamental eigenmode frequency, and wherein the oscillation signal excites one of the higher-order eigenmodes.

18. A scanning probe microscope according to claim 1, wherein the cantilever has a fundamental eigenmode with a fundamental eigenmode frequency, and one or more higher-order eigenmodes each having a frequency higher than the fundamental eigenmode frequency, and wherein the oscillation signal excites one of the higher-order eigenmodes.

19. A scanning probe microscope according to claim 18, further comprising a Q-control module configured to apply a Q-control signal to the actuation beam to damp oscillation of the cantilever at the fundamental eigenmode frequency.

20. A scanning probe microscope according to claim 18, further comprising a filter which is configured to filter the measurement signal by passing the frequency of the higher-order eigenmode and blocking other frequencies, thereby producing a filtered measurement signal, wherein the photothermal offset signal and the height control signal are adjusted by the control system on a basis of the filtered measurement signal.
